(19) United States
(12) Patent Application Publication
(10) Pub. No.: US 2014/0046739 A1
(43) Pub. Date: Feb. 13, 2014

(54) ADVERTISING PLUG-INS VIA IN-PRODUCT MESSAGING

(71) Applicants: Shawn A. Gaither, Raleigh, NC (US); Lalit Vohra, New Delhi (IN); Randy Lee Swineford, Sunnyvale, CA (US)

(72) Inventors: Shawn A. Gaither, Raleigh, NC (US); Lalit Vohra, New Delhi (IN); Randy Lee Swineford, Sunnyvale, CA (US)

(73) Assignee: ADOBE SYSTEMS INCORPORATED, San Jose, CA (US)

(21) Appl. No.: 13/572,370

(22) Filed: Aug. 10, 2012

(51) Int. Cl. G06Q 30/02

(52) U.S. Cl. 705/14.4

(57) ABSTRACT

An advertisement is detected and obtained. A plug-in associated with the advertisement is determined and the determined plug-in is obtained. The advertisement is displayed in an application user interface; in response to receiving user approval via the displayed advertisement, the plug-in is installed and an application user interface is updated to display a user interface control associated with the plug-in.

### BACKGROUND OF THE INVENTION

Companies often want to send messages to product users, for example to inform them about new plug-ins to an application. Some in-application advertising techniques are not able to do this because they only work if the plug-in already exists in the application (e.g., an older version is already installed). For brand new plug-ins, this type of in-application messaging mechanism does not work. Another issue with other advertising techniques is that they display advertisements to all users of the application, even though the message may be of interest only to some users. New techniques for delivering messages which overcome some or all of these drawbacks would be desirable.

### BRIEF DESCRIPTION OF THE DRAWINGS

Various embodiments of the invention are disclosed in the following detailed description and the accompanying drawings.

FIG. 1A is a diagram showing an embodiment of a user interface at a first point in time where the user interface is configured to display an advertisement within the user interface.

FIG. 1B is a diagram showing an embodiment of a user interface at a second point in time where the user interface is configured to display an advertisement within the user interface.

FIG. 2 is a flowchart illustrating an embodiment of a process for advertising a plug-in within an application user interface.

FIG. 3 is a diagram showing an embodiment of a system for advertising a plug-in within an application user interface.

FIG. 4 is a diagram illustrating an embodiment of a SPA plug-in.

FIG. 5 is a diagram showing an embodiment of variants.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

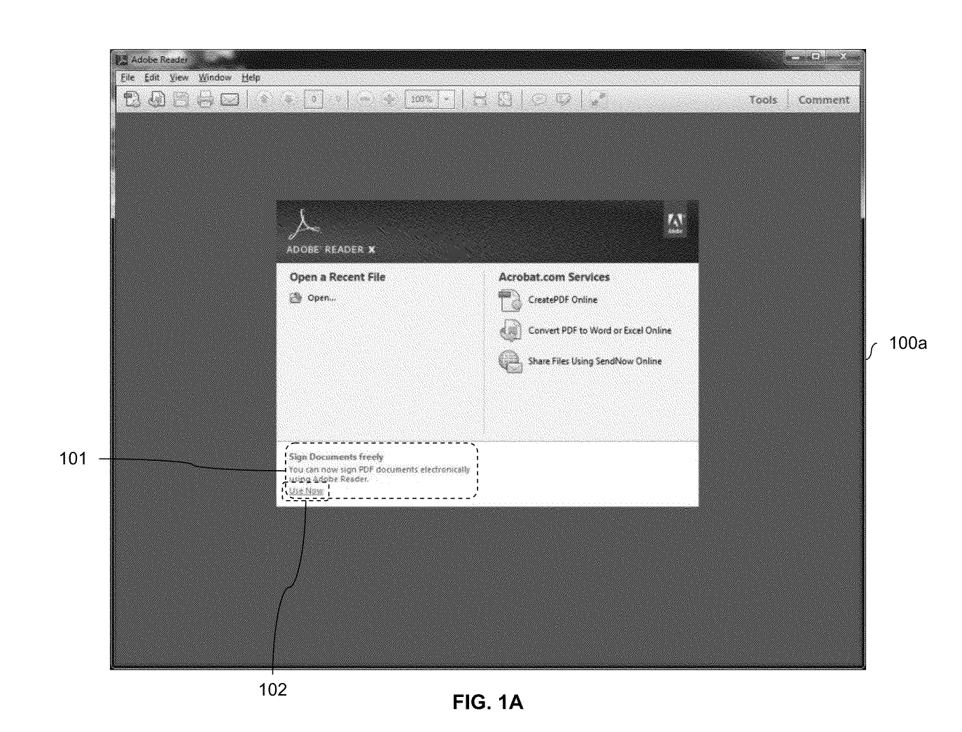

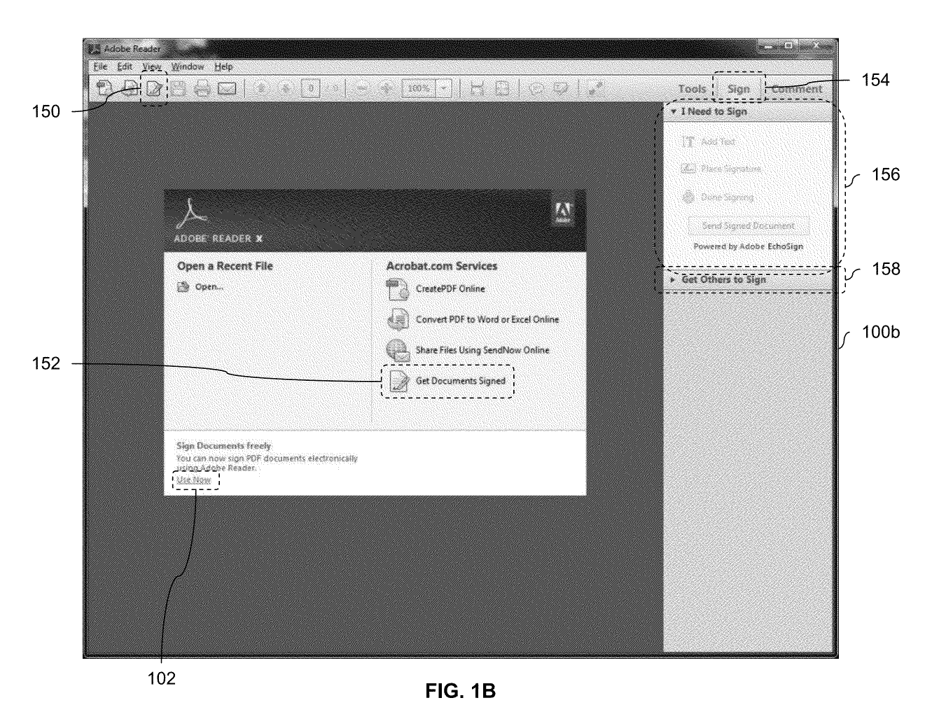

FIG. 1A is a diagram showing an embodiment of a user interface at a first point in time where the user interface is configured to display an advertisement within the user interface. In the example shown, user interface 100a (associated with Adobe Acrobat) provides a variety of services and/or processes associated with accessing, editing, and managing documents (e.g., PDF documents). At the point in time shown, Adobe Acrobat has just been started and there is no file open by the application.

Within user interface 100a, advertisement 101 is located in the bottom left corner of the central window and says, “Sign Documents freely. You can now sign PDF documents electronically using Adobe Reader. Use Now.” In the example shown, advertisement 101 is located in a centralized location which the user always sees at start up in Adobe Acrobat.

In some embodiments, display of advertisement 101 within user interface 100a is platform dependent (that is, different platforms may or may not be enabled and all platforms are not necessarily required). In some cases this is a design or implementation choice and/or is an acceptable difference between a (for example) Windows version of Adobe Acrobat and a MacOS version of Adobe Acrobat. For example, the majority of Adobe Acrobat users may use Windows so it may be both acceptable and an implementation choice to only show advertisement 101 in Windows versions of Adobe Acrobat.

In this example, pressing the “Use Now” link 102 causes the user interface shown in the next figure to be presented. Link 102 is an example of an interactive user interface control; some other types of interactive user interface controls may be used in other embodiments and include buttons, pull downs, check boxes, radio dials, and so on.

FIG. 1B is a diagram showing an embodiment of a user interface at a second point in time where the user interface is configured to display an advertisement within the user interface. In the example shown, user interface 100b is presented by Adobe Acrobat in response to a user clicking on link 102.

There are a number of new elements presented by user interface 100b which were not present in user interface 100a. These new elements include: sign button 150 in the upper left corner, “Get Documents Signed” link 152 in the center of user interface 100b, “Sign” pane 154 in the upper right corner, “I Need to Sign” panel 156 in the upper right corner, and “Get Others to Sign” panel 158 in the upper right corner.

FIGS. 1A and 1B show one embodiment of a central mechanism which enables a user to learn about a completely new plug-in (i.e., it is not an update of an already-installed plug-in). With some other advertising mechanisms, it would not be possible to inform the user about a brand new plug-in in a context appropriate manner and/or in a central place, since those advertising mechanism may require an older version of the plug-in to already be installed. It may be undesirable to surprise the user by introducing a pop-up, or something similar, which introduces new functionality which (seemingly) has nothing to do with the user's actions. Such presentations may lead to confusion, making the user less likely to accept the new functionality. The advertising mechanism described herein is not necessarily so limited.

In some embodiments, an advertisement (e.g., 101) has access to APIs and/or other interfaces exposed by the application (e.g., Adobe Acrobat) and/or the plug-in being advertised (in this example, an electronic signature plug-in). For example, clicking on link 102 may cause the advertisement to send an instruction to an API or other interface exposed by the exemplary electronic signature plug-in, causing the electronic signature plug-in to display button 150, link 152, pane 154 and/or panels 156 and 158. In some embodiments, a platform (such as a Services Plug-In Architecture (SPA) platform) is used to obtain a plug-in being advertised (in this example, the electronic signature plug-in). Such plug-ins may perform a variety of services and functions which are not necessarily provided by the underlying application (e.g., Adobe Acrobat) and in at least some cases can only be obtained by installing the plug-in. The electronic signature plug-in is merely exemplary and plug-ins are not necessarily so limited. In various embodiments, a plug-in is able to access cloud-based services, includes a sophisticated user interface experience (e.g., panels and calculations), can be easily created, and/or can interact with native user interface elements (e.g., user interface controls and/or services that are native to Adobe Acrobat as opposed to the plug-in). In various embodiments, an out-of-band update of a plug-in is supported (e.g., detection, distribution, and/or execution of a plug-in is not dependent a version update of Adobe Acrobat), a plug-in has access to Access to the JavaScript Document Object Model (DOM) Application Programming Interfaces (APIs), and/or a plug-in is able to provide bidirectional communication.

In addition to being able to advertise brand new plug-ins (e.g., within the user interface in a prominent and/or central location), another benefit to the technique described herein is that it permits targeted advertisement, if so desired. Some other advertising techniques cast a wide net and send advertisements to all users, some of whom may have no interest in the advertisement or are not affected by the plug-in being advertised. For example, if a message relates to a brand new plug-in which is only available to Chinese users, it is not of interest to non-Chinese users. Using target information (if desired), advertisements about the plug-in may be targeted to Chinese users (or users meeting some other criteria). This cuts down on the number of irrelevant messages, which permits more meaningful messages to be presented. Another benefit is the reduced amount of network traffic which saves money. Other criteria by which messages are targeted may be employed; some other examples are described in further detail below.

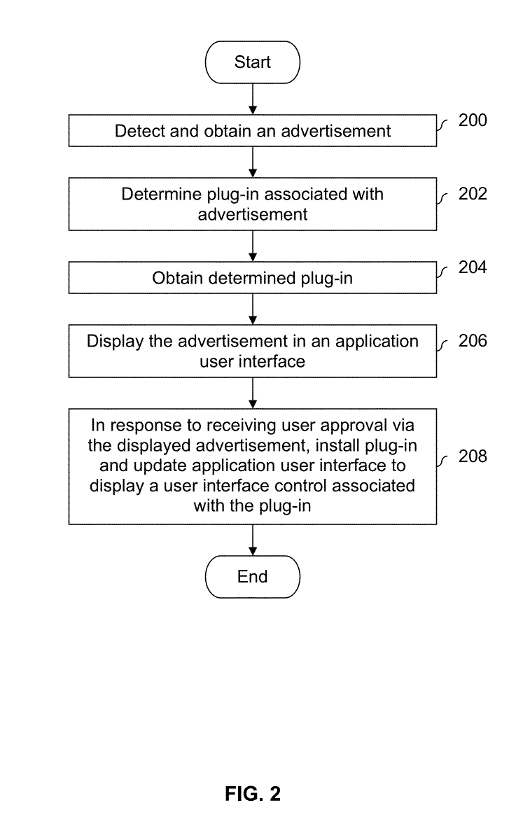

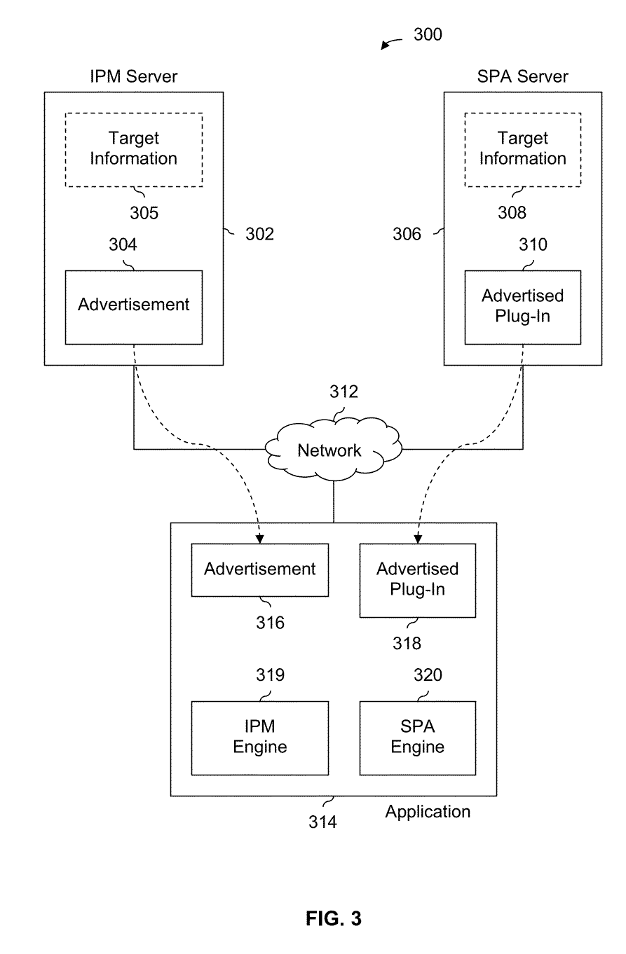

FIG. 2 is a flowchart illustrating an embodiment of a process for advertising a plug-in within an application user interface. For example, the process may be used to present user interfaces 100a and 100b in FIGS. 1A and 1B. The exemplary process will be explained using the exemplary system shown in FIG. 3 for reference. FIG. 3 is a diagram showing an embodiment of a system for advertising a plug-in within an application user interface.

At 200, an advertisement is detected and obtained. For example, in FIG. 3, application 314 (e.g., Adobe Acrobat) Acrobat contacts in-product messaging (IPM) server 302 and notices that there is a new advertisement that it has not seen before. For example, there may be some list or manifest of advertisements on IPM server 302 which application 314 can use to detect new advertisements. Advertisement 304 is copied from IP server 302 to application 314 as advertisement 316.

Returning back to FIG. 2, a plug-in associated with the advertisement is determined at 202. For example, in FIG. 3, advertisement 316 is forwarded within Adobe Acrobat to the proper owner, in this case SPA engine 320 via some organizing or mapping mechanism. For example, the name of advertisement 316 is pre-pended with “Services:” which indicates that it is associated with and/or managed by SPA engine 320. This mapping (i.e., pre-pended the name of advertisement 316 with “Services:”) is merely exemplary and in some other embodiments some other mapping or association is used.

Once advertisement 316 is sent to SPA engine 320, SPA 320 determines the plug-in associated with advertisement 316. For example, SPA engine 320 may access advertisement 316 to determine what plug-in is called by advertisement 316. In some embodiments, advertisement 316 includes metadata (e.g., separate from and/or not used during a call to the advertised plug-in triggered by a user giving approval to install a plug-in being advertised) which is checked by SPA engine 320 to determine the associated plug-in. In some embodiments, there is no separate metadata section, and advertisement 316 is probed or parsed (e.g., without actually triggering a call to an associated plug-in) in order to determine an associated plug-in.

At 204 in FIG. 2, the determined plug-in is obtained. For example, in FIG. 3, SPA engine 320 copies advertised plug-in 310 from SPA server 306 to application 314 as advertised plug-in 318. In some embodiments, SPA server 306 includes a manifest which list available plug-ins on SPA server 306, which permits SPA engine 320 to detect (newly-available) advertised plug-in 310 and/or determine it is the one associated with and/or called by advertisement 316. In various embodiments, steps are performed in any order. For example, new plug-ins may be periodically detected and obtained from SPA server 306, and the advertised plug-in 310/318 may have been obtained before download of advertisement 304/316. It some embodiments, once a SPA engine determines what plug-in is being advertised or called by a particular advertisement, the SPA engine checks to see if that plug-in has already been download; if the plug-in is not already download, then it is downloaded immediately.

The advertisement is displayed in an application user interface at 206 in FIG. 2. For example, in user interface 100a in FIG. 1A, advertisement 101 is displayed. In some embodiments, SPA engine 320 in FIG. 3 queries each plug-in already on (but not necessarily installed) application 314 in FIG. 3 as to whether it is the plug-in of interest not, and if so, is it ready. This may, for example, prevent a premature presentation of advertisement 101 before the plug-in being advertised is completely downloaded and ready for installation.

At 208 in FIG. 2, in response to receiving user approval via the displayed advertisement, a plug-is installed in and an application user interface is updated to display a user interface control associated with the plug-in. User interface 100b in FIG. 1B, for example, is updated to display button 150, link 152, pane 154, and panels 156 and 158. As is shown in FIGS. 1A and 1B, in at least some embodiments, the plug-in is installed on-the-fly without the user waiting or having to restart the application. Referring to FIG. 3, in that example system, display of user interface control(s) associated with the plug-in are triggered by an instruction sent from advertisement 316 to advertised plug-in 318 in response to receiving user approval. In some embodiments, a user interface control which is displayed in response to an instruction from advertisement 316 is not necessarily built for the use of advertisement 316 alone. For example, once plug-in 318 is installed, application 314 may send an instruction to those same interfaces or services called by advertisement 316 each time the application is started.

In some embodiments, display at 206 is permitted to occur only when an application is started. For example, if one or both of an advertisement and the associated plug-in are not yet installed when application is started, the advertisement is not displayed. This prevents a situation from occurring where a user approves installation of a plug-in, but the plug-in is not yet fully downloaded and it therefore cannot be started via the advertisement. If both are not downloaded when an application is started, the application waits until the next time the application is started.

In some embodiments, which advertisements are displayed is cycled any time that an advertisement is shown. In some embodiments, each time no document is actually open (e.g., as is shown in FIGS. 1A and 1B), but the application is still running, an advertisement panel is shown.

In various embodiments, advertisements are shown in a variety of embellishments to (for example) more easily catch a user's attention and/or which is based on the urgency or importance of that advertisement. Some examples include: bold, italic, all-cap, flashing, scrolling, etc.

In various embodiments, SPA server 306 is managed by a third-party (e.g., Akamai) and/or IPM server 302 is managed by the software company which produces application 314 (e.g., Adobe in the case of Adobe Acrobat). In some embodiments, using two servers permits new advertisements to be updated independently of the plug-ins for the application, which allows more flexibility. In some other embodiments, the same server is used to distribute an advertisement and an associated plug-in being advertised.

In some embodiments, the advertisement technique described herein is used to advertise a plug-in which is already installed. For example, there may be a serious security issue (e.g., virus susceptibility or compromised server connectivity with a service), completely broken functionality, or an extremely confusing user interface where technical support is costing more money than the service is making. By showing an advertisement in an application user interface when the application is next started, the user is presented with a good opportunity to appreciate how critical the update is. Interacting with an advertisement to signal the user's permission to install a related plug-in (e.g., by clicking on a link) causes the plug-in (e.g., which addresses the security or usability issue) to be installed.

The following table gives some examples of how targeted information (e.g., 305 and/or 308) may be used to target certain users, but target information is not limited to the examples described below. Any target information which can be used to discern a unique segment of users (e.g., paying customers versus free customers, those from a given state with certain laws, those who have customer feedback turned on, etc.) may be used.

TABLE 1
Examples of target information

| Example Target Information | Examples |
|---|---|
| Platform | Microsoft Windows, Apple Mac OS, Android |
| Product | Adobe Acrobat Reader, Adobe Acrobat |
| | Standard, Adobe Acrobat Pro |
| Enterprise Users | Identifies enterprise users and, if so, the |
| | particular company the enterprise user is |
| | associated with. If a user is an enterprise user, |
| | a company or enterprise which a user is a |
| | member of, and/or rules associated with that |
| | company or enterprise may be obtained by |
| | checking a restricted registry area associated |
| | with the application (e.g., a restricted registry |
| | managed by Adobe Acrobat). In some |
| | embodiments, an enterprise customer sets a |
| | registry entry for all its users (which normal |
| | customers would not have set). The plug-ins |
| | then make use of that entry to behave in some |
| | different fashion when the plug-in sees that |
| | registry entry set. MacOS also supports this |
| | via a special property list file. Other platforms |
| | use other mechanisms as program resources. |
| Start Date | Indicates earliest permitted start date of a plug- |
| | in. The plug-in may be downloaded prior to |
| | the start date, but not installed until the |
| | specified start date. If not specified, the |
| | plug-in is installed at the first opportunity. |
| Revert Date | Indicates end date of a plug-in (e.g., may be |
| | used to specify an end date to test out a variety |
| | of messages). |
| Language | Language of the message (and therefore the |
| | language of users for which the message is |
| | relevant). |
| Variant Name(s) and | Used to randomly determine whether to |
| Percentage(s) | display a message using a messaging plug-in. |
| | An example is described in further detail |
| | below. |

In this example, IPM server 302 has its own unique set of classifications (i.e., target information 308 which may include: Windows vs. MacOS, Pro vs. free Reader, etc.) that are unique and separate from those defined by SPA server 306 (i.e., target information 305). Put another way, in this example, an advertisement is defined as relevant in a fashion independent from that of an SPA plug-in. An advertisement's link to an associated SPA plug-in is via definition of its action. For example, an advertisement (e.g., 316) might be classified as “Services:Sign:OpenPane” which SPA engine 320 identifies as one of its own (e.g., because of the “Services:” as its classification). SPA engine 320 further parsers the classification and qualifies “Sign:” as requiring the exemplary electronic signature plug-in and the “OpenPane” action within the electronic signature plug-in. In the actual electronic signature plug-in, the OpenPane action might only be defined for a platform (e.g., Windows), configuration (e.g., Reader only), or even a specific variant (e.g., using target information 308). It is then up to SPA engine 320 to inform the IPM engine 319 that it knows of the action and either can or cannot perform the action based on its overall configuration. IPM engine 319 has (at least in this example) no knowledge of SPA plug-ins or how they are configured. It is up to SPA engine 320 to decide what to do based on the provided classification (i.e., “Services:Sign:OpenPane”) and pass that status back to IPM engine 319. If so permitted, IPM engine 319 can then display that message as an advertisement, and later tells the SPA engine 320 to perform the action once the user clicks on an associated user interface control. Conceptually, the two mechanisms (i.e., the IPM mechanism and the SPA plug-in mechanism) are independent of each other and are coupled via a name or identifier. In some applications this is attractive because a SPA plug-in may be updated to completely redefine what the action does, or for which configurations it matches, and the IPM infrastructure or mechanism could remain completely intact.

In some embodiments, the target information compared against local configuration information to determine if the advertisement or plug-in should be downloaded. Local configuration information may be obtained from a variety of sources and/or a variety of locations. In some embodiments, registry area (some of which may be restricted) associated with an application (e.g., Adobe Acrobat) is accessed and location configuration information is obtained from there.

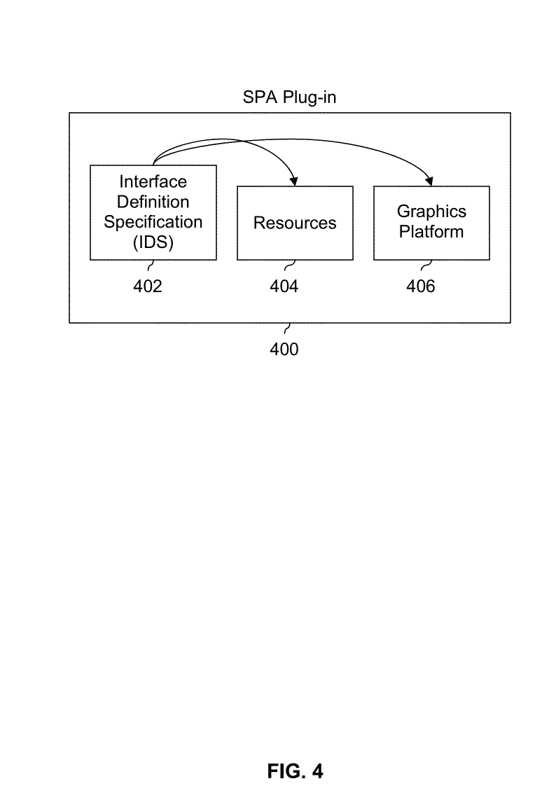

FIG. 4 is a diagram illustrating an embodiment of a SPA plug-in. Interfaces, services, and/or functions exposed by SPA plug-in 400 are used to update an application user interface to display a user interface control associated with the plug-in in response to user approval (e.g., by clicking on link 102 in FIG. 1A). In some embodiments, electronic signature plug-in associated with user interface 100b in FIG. 1B is implemented as shown. In some embodiments, a plug-in includes other components in addition to those described herein.

SPA plug-in 400 includes interface definition specification (IDS) 402. In general, IDS 402 contains metadata describing the SPA plug-in, including (but not limited to) the contents of a SPA plug-in wrapper or package (e.g., SPA plug-in 400). In various embodiments, IDS 402 includes: identifying attributes of the SPA plug-in (e.g., a unique identifier, a version number), user interface elements of the SPA plug-in to be displayed via an application user interface (e.g., panels, menu items, buttons, etc.), actions performed by the SPA plug-in via an application user interface (e.g., new panes, logging, events, or pop-ups not native to the application), references to resources used or called by the SPA plug-in (e.g., access strings, icons, databases, or storage), etc. In some embodiments, IDS 402 includes metadata about resources 404 and/or actions 406.

In this particular example, IDS 402 includes references to resources 404 and actions 406, which are also components of SPA plug-in 400. Resources 404 include resources called by or used by an SPA plug-in and a variety of items, such as icons, strings, data files, and/or accessible storage or devices. In some embodiments, resources 404 include common resources (e.g., which are available or used globally) and localized resources (e.g., for use in specific locales).

Graphics platform 406 is used to draw (e.g., buttons, checkboxes and other user interface controls) to an application user interface. In some embodiments, graphics platform 406 is a SWF file. A SWF supports all three key concepts of a Model-View-Controller (MVC) model and is an example of a compiled, self-contained, platform-independent graphics platform. At least in the case of SWF files, the model is handled via the logic which is available to a SWF via the underlying ActionScript code which is compiled into the SWF. ActionScript and SWFs, compared to some other MVC models, may be attractive because the MVC model is platform-independent (e.g., like Java). Some other user interface platforms are platform-specific (e.g. XCode for iOS is specific to Apple platforms). However, whatever the platform, they all typically support some form of graphical interface builder IDE (e.g. the Adobe Flash/Flex Builder) along with a programming language interface (e.g. ActionScript), and via some form of compiler spit out an executable of some form (e.g. a SWF file).

In some embodiments, variant names and percentages are used to display advertisements with a degree of randomness. The following figure shows an example of variant names and percentages.

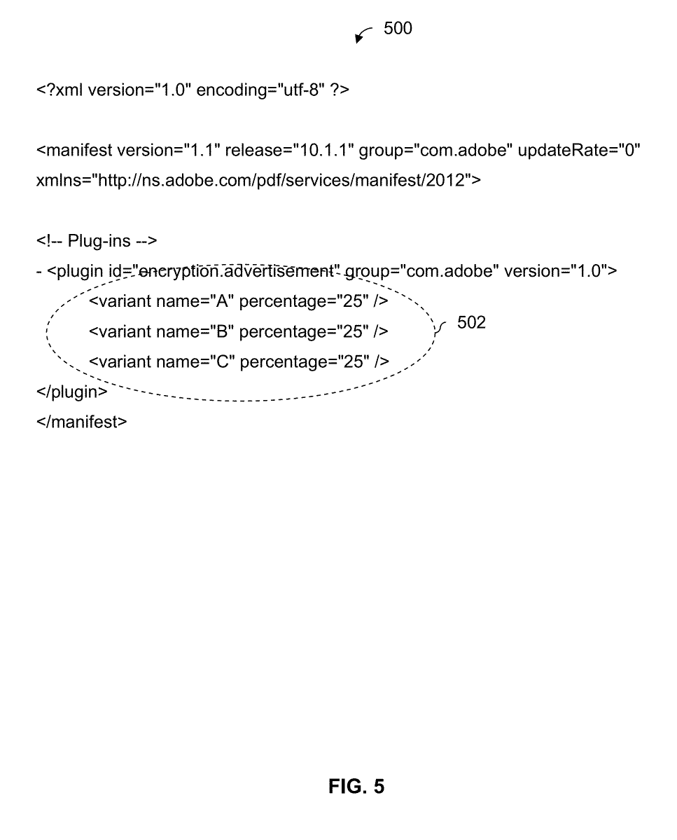

FIG. 5 is a diagram showing an embodiment of variants. In some embodiments, variants (e.g., implemented as shown) are located on target information 305 and/or 308 in FIG. 3. In this particular example, a manifest (e.g., on IPM server 302 or SPA server 306 in FIG. 3) which lists advertisements or plug-ins includes variants. In some embodiments, variants include other elements in addition to or as an alternative those described herein.

SPA manifest 500 includes variant information 502. In this example, 3 variants are defined: variant A with a percentage or probability of 25%, variant B with a percentage or probability of 25%, and variant C with a percentage or probability of 25%. Although 3 variants are shown in this example, any number of variants may be used (e.g., just variant A). A number in the range [1, 100] (i.e., inclusive of 1 and 100) is selected. If the randomly-selected number is in the range of [1, 25] then variant A (i.e., the first variant encountered when parsing variant information 502) is used, if the randomly-selected number is in the range of [26, 50] then variant B (the second variant encountered when parsing variant information 502) is used, and if the randomly-selected number is in the range of [51, 75] then variant C is used. If the randomly-selected number is greater than or equal to 76 then the plug-in is not updated. Each of the variants may be associated with a different aspect of the plug-in, including the plug-in itself. Note that variants are applicable to panes, panels, menu items, buttons, links, text actions, and even as ActionScript conditionals. In general, variants allow for complete modification of the plug-in in any way, shape, or form desired.

Variants may be used to randomly displaying messages for a variety of applications. For example, release of a brand-new plug-in may be planned and a company may want to determine the most effective way of informing users about the plug-in. In one example of how variants are used, 5% of users are presented with a first message about the plug-in, 5% of users are presented with a second message about the plug-in, and the remaining 90% of users are ignored (i.e., they are not part of the test). By observing the responses of the users presented with the first and second users, the most effective way to inform users about the plug-in may be determined. For example, contents of one message may be more persuasive than the other, causing viewers of that message to approve activation of the new plug-in in greater numbers. Or, the location of one message may be determined to be more effective than the other. Using variants, trial messages may be tested on a portion of the user base before being released on a wider scale. Over all, one of the test messages is displayed only 10% of the time in the example above.

Variants may be combined with other target information so that a particular message is only presented to a random number of users, devices, or configurations which meet certain criteria. For example, a message may be delivered to a certain percentage of non-enterprise users; enterprise users in that example would not be presented with the message. Another example is a new plug-in that is English-only (e.g., because there was not enough time to localize the plug-in). At a later point, a revision comes along that contains tier one locales (e.g., French, German, Spanish), followed by tier two (Chinese, Japanese, Korean), etc.

In some embodiments, a decision whether to display a message (which includes a random factor) is made each time an application is started. For example, if a message is to be presented to 5% of users, each time a user starts the application then that user has a 5% chance of viewing the message. In such embodiments, just because a user is presented with the message one time does not necessarily mean that that user will see the message again the next time he runs that application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
detecting and obtaining an advertisement;
using a processor to determine a plug-in associated with the advertisement;
obtaining the determined plug-in;
displaying the advertisement in an application user interface; and
in response to receiving user approval via the displayed advertisement, installing the plug-in and updating an application user interface to display a user interface control associated with the plug-in.

2. The method of claim 1, wherein displaying the message includes one or more of the following: displaying the advertisement a subsequent time an application associated with the application user interface is run or displaying the advertisement without relying upon a user action to trigger display of the advertisement.

3. The method of claim 1, wherein displaying the message includes using one or more of the following: bold, italic, all-cap, flashing, or scrolling.

4. The method of claim 1, wherein updating the application user interface includes sending an instruction, from the advertisement to the plug-in, which causes the plug-in to display the user interface control.

5. The method of claim 1 further comprising:
obtaining target information associated with the advertisement;
determining, based at least in part on the target information, whether to obtain the advertisement; and
in the event it is determined not to obtain the advertisement, not performing the steps of obtaining the determined plug-in, display the advertisement, and installing the plug-in and updating the application user interface.

6. The method of claim 5, wherein the target information includes information associated with one or more of the following: a platform, a product, whether a user is an enterprise user, a start date, a revert date, a language, or random assignment of the plug-in.

7. A computer program product, the computer program product being embodied in a tangible computer readable storage medium and comprising computer instructions for:
detecting and obtaining an advertisement;
determining a plug-in associated with the advertisement;
obtaining the determined plug-in;
displaying the advertisement in an application user interface; and
in response to receiving user approval via the displayed advertisement, installing the plug-in and updating an application user interface to display a user interface control associated with the plug-in.

8. The computer program product of claim 7, wherein the computer instructions for displaying the message include computer instructions for one or more of the following: displaying the advertisement a subsequent time an application associated with the application user interface is run or displaying the advertisement without relying upon a user action to trigger display of the advertisement.

9. The computer program product of claim 7, wherein the computer instructions for displaying the message include computer instructions for using one or more of the following: bold, italic, all-cap, flashing, or scrolling.

10. The computer program product of claim 7, wherein the computer instructions for updating the application user interface include computer instructions for sending an instruction, from the advertisement to the plug-in, which causes the plug-in to display the user interface control.

11. The computer program product of claim 7 further comprising computer instructions for:
obtaining target information associated with the advertisement;
determining, based at least in part on the target information, whether to obtain the advertisement; and
in the event it is determined not to obtain the advertisement, not performing the steps of obtaining the determined plug-in, display the advertisement, and installing the plug-in and updating the application user interface.

12. The computer program product of claim 11, wherein the target information includes information associated with one or more of the following: a platform, a product, whether a user is an enterprise user, a start date, a revert date, a language, or random assignment of the plug-in.

13. A system, comprising:
a processor; and
a memory coupled with the processor, wherein the memory is configured to provide the processor with instructions which when executed cause the processor to:
detect and obtain an advertisement;
determine a plug-in associated with the advertisement;
obtain the determined plug-in;
display the advertisement in an application user interface; and
in response to receiving user approval via the displayed advertisement, install the plug-in and updating an application user interface to display a user interface control associated with the plug-in.

14. The system of claim 13, wherein the instructions for displaying the message include instructions for one or more of the following: displaying the advertisement a subsequent time an application associated with the application user interface is run or displaying the advertisement without relying upon a user action to trigger display of the advertisement.

15. The system of claim 13, wherein the instructions for displaying the message include instructions for using one or more of the following: bold, italic, all-cap, flashing, or scrolling.

16. The system of claim 13, wherein the instructions for updating the application user interface include instructions for sending an instruction, from the advertisement to the plug-in, which causes the plug-in to display the user interface control.

17. The system of claim 13, wherein the memory is further configured to provide the processor with further instructions which when executed cause the processor to:
obtain target information associated with the advertisement;
determine, based at least in part on the target information, whether to obtain the advertisement; and
in the event it is determined not to obtain the advertisement, not perform the steps of obtaining the determined plug-in, display the advertisement, and installing the plug-in and updating the application user interface.

18. The system of claim 17, wherein the target information includes information associated with one or more of the following: a platform, a product, whether a user is an enterprise user, a start date, a revert date, a language, or random assignment of the plug-in.
